(19) United States
(12) Patent Application Publication
(10) Pub. No.: US 2026/0356199 A1
(43) Pub. Date: Nov. 12, 2026

(54) AUTO INTERIOR DISPLAYS COMPRISING AN ARCHITECTED MATERIAL

(71) Applicant: CORNING INCORPORATED, CORNING, NY (US)

(72) Inventors: Kaikai Che, Rochester, NY (US); Khaled Layouni, Fontainebleau (FR); Yousef Kayed Qaroush, Painted Post, NY (US)

(21) Appl. No.: 19/133,391

(22) PCT Filed: Dec. 1, 2023
(86) PCT No.: PCT/US2023/081982

§ 371 Date: May 28, 2025

Related U.S. Application Data
(60) Provisional application No. 63/430,212, filed on Dec. 5, 2022.

(51) Int. Cl. B60K 35/70; B60K 35/22; B60K 35/60; B60R 21/05

(52) U.S. Cl. CPC B60K 35/70; B60K 35/22; B60K 35/60; B60R 21/05; B60K 2360/782

(57) ABSTRACT

Display modules comprising mechanical systems and methods to improve energy absorption for HIT compliance and to prevent breakage during impact. The display module can comprise an architected material comprising a designed geometry. The architected material can be disposed under a glass substrate of the display module or an attachment of the display module. The architected material can comprise one or more energy absorbing unit cells, each energy absorbing cell unit comprising a variable compressive stiffness defined by a slope of a force versus normalized displacement curve for a top surface of the energy absorbing unit cell.

### CROSS-REFERENCE TO RELATED APPLICATIONS

This application claims the benefit of priority under 35 U.S.C. § 119 of U.S. Provisional Application Ser. No. 63/430,212 filed on Dec. 5, 2022, the content of which is relied upon and incorporated herein by reference in its entirety.

### FIELD

The present disclosure relates to display assemblies for use in various industries, for example, consumer electronics, appliances, transportation, architecture, defense, and medicine. In particular, the present disclosure relates to displays with mechanical systems and methods for improving the dynamic response to impact.

### BACKGROUND

Many products include interior displays. Some examples of interior displays are automobile interior displays. In auto interior applications, these interior displays must meet performance requirements for head form impact testing (HIT). Use of glass to cover these auto interior displays presents challenges in satisfying HIT regulations while remaining intact during impact.

Therefore, a continuing need exists for efficient and effective methods of forming interior displays, particularly for automobiles, that both meet regulatory requirements and are not broken during impact.

### BRIEF SUMMARY

A first aspect (1) of the present application is directed to a vehicle interior system, the vehicle interior system comprising a vehicle interior base and a display module disposed over the vehicle interior base. The display module comprises a glass substrate comprising a first surface and a second surface opposing the first surface, an electronic display attached to the first surface of the glass substrate, and an architected material comprising an energy absorbing unit cell. The energy absorbing unit cell comprises a variable compressive stiffness defined by a slope of a force versus normalized displacement curve for a top surface of a top edge of the energy absorbing unit cell. The variable compressive stiffness comprises a first positive slope region across of first range of normalized displacement, a negative slope region across a second range of normalized displacement, and a second positive slope region across a third range of normalized displacement.

In a second aspect (2), the first surface of the glass substrate according to the first aspect (1) comprises a curved surface.

In a third aspect (3), the architected material according to the first aspect (1) or the second aspect (2) is disposed between the first surface of the glass substrate and the vehicle interior base.

In a fourth aspect (4), the architected material according to any one of aspects (1)-(3) is attached to the first surface of the glass substrate.

In a fifth aspect (5), the vehicle interior system according to any one of aspects (1)-(4) further comprises an attachment coupling the display module to the vehicle interior base, where the architected material is disposed between the attachment and the vehicle interior base.

In a sixth aspect (6), the architected material according to any one of aspects (1)-(5) is attached to the vehicle interior base.

In a seventh aspect (7), the architected material according to any one of aspects (1)-(6) comprises a plurality of the energy absorbing unit cells arranged in a plurality of rows.

In an eighth aspect (8), the display according to any one of aspects (1)-(7) is visible through an opening formed in the architected material.

In a ninth aspect (9), the architected material according to any one of aspects (1)-(8) comprises a thickness that is greater than a thickness of the glass substrate.

In a tenth aspect (10), the energy absorbing unit cell according to any one of aspects (1)-(9) comprises a first sidewall comprising a first curved portion and a first flat portion; and a second sidewall comprising a second curved portion and a second flat portion, where a thickness of the first curved portion and a thickness of the second curved portion is given by t, a height of the first curved portion and a height of the second curved portion is given by h, a length of the first curved portion and a length of the second curved portion is given by l/2, a non-dimensional parameter P is given by l/t, and a non-dimensional parameter Q is given by h/t.

In an eleventh aspect (11), the first curved portion and the second curved portion according to the tenth aspect (10) each comprise an S-shape defined by a first curved segment and a second curved segment connected at an inflection point.

In a twelfth aspect (12), the value of Q according to the tenth aspect (10) or the eleventh aspect (11) is greater than or equal to 2.

In a thirteenth aspect (13), the value of P according to any one of aspects (10)-(12) is between 13 and 16.

In a fourteenth aspect (14), the energy absorbing unit cell according to any one of aspects (10)-(13) comprises a top wall extending from the first curved portion to the second curved portion and a bottom wall extending from the first flat portion to the second flat portion.

In a fifteenth aspect (15), a width of the top wall according to the fourteenth aspect (14) is given by W, a width of a first side and a second side of the bottom wall is given by w, a height of a bottom side of the bottom wall is given by T, the value of w is greater than the value of t, and the value of w is less than the value of T.

In a sixteenth aspect (16), the force versus normalized displacement curve according to any one of aspects (1)-(15) does not comprise a force value below zero.

In a seventeenth aspect (17), the force versus normalized displacement curve according to any one of aspects (1)-(16) comprises a force value below zero.

In an eighteenth aspect (18), the variable compressive stiffness according to any one of aspects (1)-(17) transitions from the first positive slope region to the negative slope region at a first critical force value.

In a nineteenth aspect (19), the variable compressive stiffness according to any one of aspects (1)-(18) transitions from the negative slope region to the second positive slope region at a second critical force value.

In a twentieth aspect (20), the vehicle interior base according to any one of aspects (1)-(19) comprises at least one of a component of a vehicle dashboard, a component of a vehicle center console, a component of a vehicle instrument panel, a component of a vehicle steering wheel, a component of a vehicle seat back, a component of a vehicle seat front, or a component of a vehicle door panel.

A twenty-first aspect (21) of the present application is directed to a vehicle interior system, the vehicle interior system comprising a vehicle interior base, a glass substrate comprising a first surface and a second surface opposing the first surface, and an architected material disposed between the vehicle interior base and the glass substrate and comprising an energy absorbing unit cell, where the energy absorbing unit cell comprises a variable compressive stiffness defined by a slope of a force versus normalized displacement curve for a top surface of a top edge of the energy absorbing unit cell, the variable compressive stiffness comprising: a first positive slope region across of first range of normalized displacement, a negative slope region across a second range of normalized displacement, and a second positive slope region across a third range of normalized displacement.

### BRIEF DESCRIPTION OF THE DRAWINGS

The accompanying figures, which are incorporated herein, form part of the specification and illustrate aspects of the present disclosure. Together with the description, the figures further serve to explain the principles of and to enable a person skilled in the relevant art(s) to make and use the disclosed aspects. These figures are intended to be illustrative, not limiting. Although the disclosure is generally described in the context of these aspects, it should be understood that it is not intended to limit the scope of the disclosure to these particular aspects. In the drawings, like reference numbers indicate identical or functionally similar elements.

FIG. 1 shows a perspective view illustration of a vehicle interior with vehicle mounted display modules according to aspects.

FIG. 2 shows an exploded view of a display module according to aspects.

FIG. 3 shows a side view of a display module according to aspects.

FIG. 4 shows an architected material according to aspects.

FIG. 5 shows a unit cell of the architected material of FIG. 4.

FIG. 6 shows a force versus normalized displacement curve for the displacement of a top surface of a top edge of the unit cell of FIG. 5 according to aspects.

FIG. 7A shows an example HIT model of a display module.

FIG. 7B shows an example HIT model with an architected material.

FIG. 8A is a graph of headform deceleration versus time for the HIT models of FIGS. 7A and 7B.

FIG. 8B is a graph of glass stress versus time for the HIT models of FIGS. 7A and 7B.

FIG. 9A is a graph of headform deceleration versus time for the HIT models of FIGS. 7A and 7B.

FIG. 9B is a graph of glass stress versus time for the HIT models of FIGS. 7A and 7B.

FIG. 10A shows an example HIT model of a display module.

FIG. 10B shows an example HIT model with an architected material.

FIG. 11A is a graph of headform deceleration versus time for the HIT models of FIGS. 10A and 10B.

FIG. 11B shows is a graph of glass stress versus time for the HIT models of FIGS. 10A and 10B.

FIG. 12A is a graph of headform deceleration versus time for the HIT models of FIGS. 10A and 10B.

FIG. 12B is a graph of glass stress versus time for the HIT models of FIGS. 10A and 10B.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Interior display modules described herein can be used in a variety of applications. The display module components can comprise a glass substrate (e.g., a cover glass), an electronic display, and a material for energy absorption. The material for energy absorption can help the display module, particularly in automotive applications, to improve its dynamic response during impact to allow the display module to remain intact and meet regulatory requirements.

HIT regulations, for example, require glass breakage at a certain impact load. Relatedly, according to some HIT regulations, the deceleration of a tested head form should not exceed 80 g (g-force) continuously for more than 3 milliseconds. Increasing the capacity of the glass substrate to dissipate compressive stress can allow the glass substrate to withstand impact and prevent breakage. However, breakage at particular impact loads can be required to prevent injury. Display modules can employ a high strength glass designed to be thin to meet HIT regulations and allow for breakage at threshold impact loads. However, designs with high strength thin glass can be vulnerable to breakage during impact below threshold impact loads as well, which can be undesirable for OEM (original equipment manufacturer) parts. Display modules described herein can prevent breakage below threshold impact loads, meet HIT regulations, and have a cost-effective design.

According to a non-limiting aspect, an architected material can be used for the energy absorption and improve the dynamic response of the display module during impact. To achieve this improvement, meet HIT regulations, and prevent the glass substrate of the display module from breaking easily, the architected material can comprise a designed geometry. In aspects, the architected material can exploit elastic instabilities under compression by utilizing elastic buckling to improve the energy absorption of the display module. As described herein, the architected material can buckle such that it moves between configurations once critical force values are reached such that the architected material has a negative stiffness under compressive loading. Compared with plastic or foam plates without the designed geometry, the architected material has several advantages, such as the ability to return to its initial position and configuration after impact, and repeatability of mechanical energy absorption to accommodate additional impact. The architected material can improve the HIT behavior of the display module by lowering the deceleration of a test headform and the maximum stress on the glass. The improved dynamic performance of the display module from the addition of the architected material can be beneficial to meet HIT regulations and prevent breakage of the glass substrate during impact.

In aspects, the architected material can comprise one or more bistable unit cells. In such aspects, the bistable unit cells can improve energy absorption of the architected material and the display module. In other aspects, the architected material can comprise one or more monostable unit cells. As used herein, “bistable” and “monostable” can describe the response of the unit cells after an external compressive load is released. Unit cells that are bistable have a force value below zero in a force versus normalized displacement graph and may remain in a deformed state after an external compressive load is released. Unit cells that are monostable do not have a force value below zero in a force versus normalized displacement graph and can return to their initial un-deformed state after an external load is released.

In aspects, the architected material can comprise PC ABS, which is a polycarbonate and ABS (acrylonitrile butadiene styrene) material blend. In aspects, the architected material can comprise a thermoplastic polymer. In aspects, the architected material can comprise a plastic foam. Exemplary plastic foams, include, but are not limited to, a polyurethane foam or a polyethylene foam.

As used herein, the term “cold-formed” or “cold-forming” (which also can be called “cold-bent” or “cold-bending”) refers to curving the glass substrate at a cold-forming temperature that is less than the softening point of the glass. For example, in aspects, cold-forming a glass substrate can be performed at a temperature of about 100 degrees Celsius or less. In aspects, cold-forming a glass substrate can be performed at a temperature of about 30 degrees Celsius or less. In aspects, cold-forming a glass substrate can be performed at a temperature ranging from about 20 degrees Celsius to about 100 degrees Celsius, including subranges. For example, cold-forming a glass substrate can be performed at a temperature ranging from about 20 degrees Celsius to about 100 degrees Celsius, about 20 degrees Celsius to about 60 degrees Celsius, or about 20 degrees Celsius to about 30 degrees Celsius, or within a range having any two of these values as endpoints.

As used herein, “disposed on” means that a first layer or component is in direct contact with a second layer or component. In other words, if a first layer or component is disposed on a second layer or component, there are no layers or components disposed between the first layer or component and the second layer or component. A first layer or component described as “attached to” a second layer or component means that the layers or components are attached to each other via an adhesive layer. A first layer or component described as “directly attached to” a second layer or component means that the layers or components are directly attached to each other via an adhesive layer with no intervening layers. If a first layer or component is described as “disposed over” a second layer or component, other layers may or may not be present between the first layer or component and the second layer or component. A first layer or component described as “disposed on” or “disposed over” a second layer or component does not imply that the first layer or component and the second layer or component were assembled in any particular order. Unless specified otherwise, the first layer or component and the second layer or component can be assembled in any order.

In aspects, the glass substrate can be cold-formed. In aspects, the display module can comprise a frame and an attachment (for example, a bracket). The attachment can be used to attach the display module to a vehicle interior, for example, to a vehicle interior base, which can be a component of a vehicle dashboard, a vehicle center console, a vehicle instrument panel, a vehicle steering wheel, a vehicle seat back, a vehicle seat front, a vehicle door panel, or any other vehicle interior part. In aspects, the glass substrate can be disposed on an adhesive layer that attaches the glass substrate to the frame and/or an architected material. In aspects, the glass substrate and an architected material can be directly attached to each other via the adhesive layer. In aspects, the display module can comprise a plurality of architected materials and the glass substrate can be disposed over the plurality of architected materials. In aspects, the attachment can be disposed over an architected material. In such aspects, an architected material can be disposed between the display module and the vehicle interior.

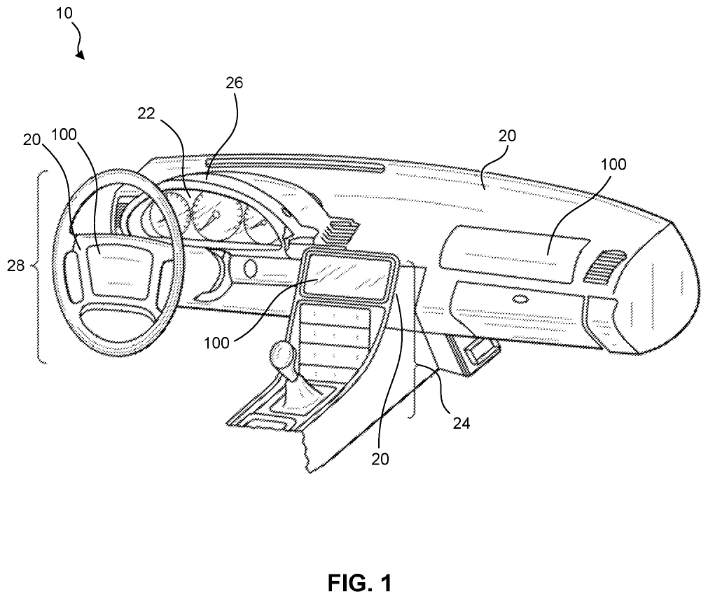

FIG. 1 shows a vehicle interior 10 comprising one or more vehicle mounted display modules 100 according to aspects. Vehicle interior can comprise one or more vehicle interior bases 20. Vehicle interior base 20 can be supported on, for example, a component of a vehicle dashboard 22, a component of a vehicle center console, 24, a component of a vehicle instrument panel 26, a component of a vehicle steering wheel 28, a component of a vehicle seat back, a component of a vehicle seat front, and/or a component of a vehicle door panel. The one or more vehicle interior bases 20 can support one or more display modules 100. Display modules 100 can be disposed over a vehicle interior base 20. In this way, display module 100 can be adapted for use in vehicle interior 10. Accordingly, display module 100 can be required to meet HIT regulations designed for automobiles that can test for impact from head collisions.

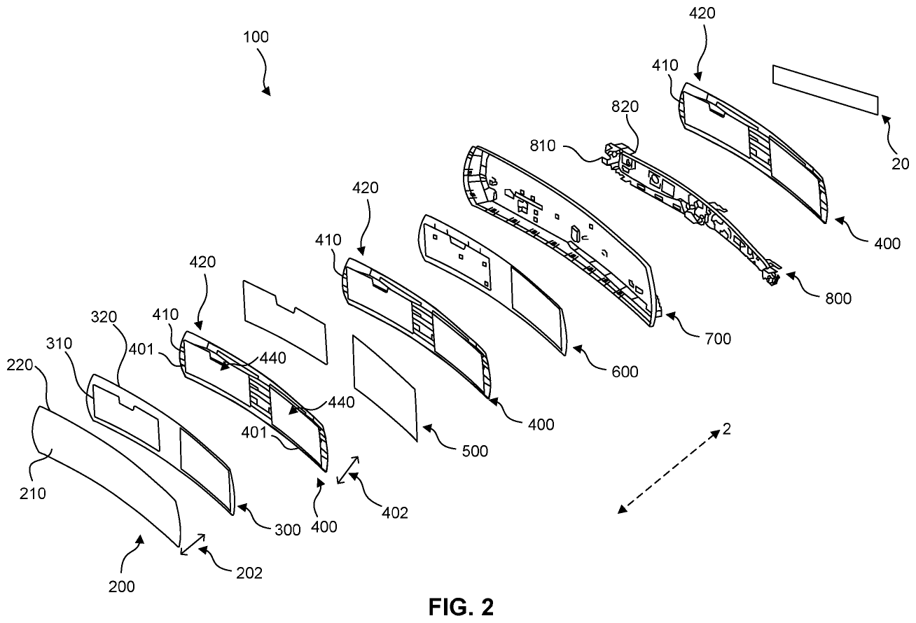

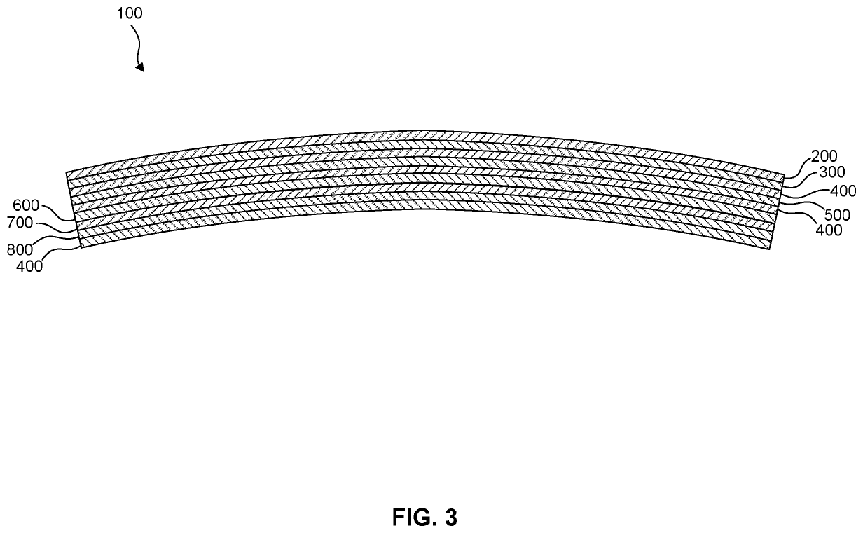

FIG. 2 shows an exploded view of a display module 100 according to aspects. FIG. 3 shows a side view along a lateral axis 2 of display module 100 in an assembled form according to aspects. As shown in FIGS. 2-3, in aspects, display module 100 can comprise a glass substrate 200 and an architected material 400. In aspects, display module 100 can comprise glass substrate 200, architected material 400, and an electronic display 500. In aspects, display module 100 can comprise glass substrate 200, an adhesive layer 300, architected material 400, and electronic display 500. As used herein, the term “electronic display” includes a touch panel, a display with or without touch functionality or an icon or surface with touch functionality. The display may include a liquid crystal display, an organic light-emitting diode (OLED) display, a micro light-emitting diode display (microLED), an active matrix OLED (AMOLED), quantum dot light-emitting diode (QLED) displays, etc. In aspects, display module 100 can comprise glass substrate 200, adhesive layer 300, and architected material 400. In aspects, adhesive layer 300 can attach glass substrate 200 to architected material 400. In aspects, adhesive layer 300 can attach glass substrate 200 to electronic display 500. In aspects, adhesive layer 300 can attach glass substrate 200 to architected material 400 and electronic display 500.

In aspects, display module 100 can comprise a frame 600. In aspects, frame 600 can be attached to glass substrate 200. In aspects, frame 600 can be attached to electronic display 500. In aspects, frame 600 can be attached to glass substrate 200 and electronic display 500. Frame 600 can support display module 100 and components thereof. In aspects, glass substrate 200 can be disposed over frame 600.

In aspects, display module 100 can comprise a back cover 700. Back cover 700 can support display module 100 and components thereof. In aspects, frame 600 can be disposed over back cover 700.

In aspects, display module 100 can comprise an attachment 800. Attachment 800 can attach display module 100 and components thereof to vehicle interior base 20 of vehicle interior 10. In aspects, attachment 800 can comprise a bracket. In aspects, attachment 800 can be directly attached to back cover 700.

In aspects, display module 100 can comprise a plurality of electronic displays 500. The one or more electronic displays 500 of display module 100 can be, for example, a liquid crystal display, a light emitting diode display, or an organic light emitting diode display.

Aspects described herein may refer to these components and/or one of each component, however it should be understood that display module 100 can comprise additional components and/or one or more of each component shown in FIGS. 2-3. Components of display module 100 can be assembled along an axis parallel to lateral axis 2.

While FIG. 1 shows an automobile interior, the various aspects of display module 100 may be incorporated into any type of vehicle such as trains, automobiles (e.g., cars, trucks, buses and the like), sea craft (boats, ships, submarines, and the like), and aircraft (e.g., drones, airplanes, jets, helicopters and the like), including both human-piloted vehicles, semi-autonomous vehicles and fully autonomous vehicles.

In aspects, glass substrate 200 can be cold-formed. Glass substrate 200 can be comprised of a suitable glass composition such as a soda lime glass, an aluminosilicate glass, a borosilicate glass, a boroaluminosilicate glass, an alkali-containing aluminosilicate glass, an alkali-containing borosilicate glass, and an alkali-containing boroaluminosilicate glass. As used herein, the term “glass substrate” is used in its broadest sense to comprise any object made wholly or partly of glass. Glass substrates can comprise laminates of glass and non-glass materials, laminates of glass and crystalline materials, and glass-ceramics (including an amorphous phase and a crystalline phase). The glass substrate can be transparent or opaque. In aspects, a cold-formed glass substrate can comprise a colorant that provides a specific color.

Glass substrate 200 can comprise a first surface 210 and a second surface 220. Second surface 220 can oppose first surface 210 of glass substrate 200. First surface 210 can be a top surface of glass substrate 200 and second surface 220 can be a bottom surface of glass substrate 200. As used herein, the terms “top surface” and “bottom surface” reference the top and bottom surface of a layer, component, or article as is would be oriented during its normal and intended use with the top surface being the user-facing surface. In aspects, a top surface of display module 100 can comprise first surface 210 of glass substrate 200. In aspects, glass substrate 200 can comprise a curved surface. In aspects, first surface 210 of glass substrate 200 can comprise a curved surface. In aspects, second surface 220 of glass substrate 200 can comprise a curved surface. In other aspects, first surface 210 and/or second surface 220 of glass substrate 200 can comprise a flat surface. In aspects, first surface 210 and/or second surface 220 of glass substrate 200 can comprise a V-shaped surface.

Adhesive layer 300 can comprise a first surface 310 and a second surface 320. In aspects, second surface 220 of glass substrate 200 can be disposed on first surface 310 of adhesive layer 300. Adhesive layer 300 can comprise a bonding material, for example, a structural adhesive or an optically clear adhesive. In aspects, the bonding material can contain a rigid, semi-rigid, or compliant spacer of material different from the structural adhesive or other bonding medium. In aspects, the bonding material can comprise Very High Bond (VHB™) tape available from 3M™.

Architected material 400 can comprise a first surface 410 and a second surface 420. In aspects, architected material 400 can be used as support for display module 100 by absorbing energy from impact to display module 100. In aspects, architected material 400 can be disposed within display module 100 under glass substrate 200. In aspects, architected material 400 can be disposed within display module 100 under electronic display 500. In aspects, architected material 400 can be disposed under attachment 800. In such aspects, architected material 400 can be disposed between attachment 800 and vehicle base 20.

In aspects, display module 100 can comprise a plurality of architected materials 400. For example, display module 100 can comprise a first architected material 400 disposed between glass substrate 200 and electronic display 500, and a second architected material 400 disposed between electronic display 500 and frame 600. As another example, display module 100 can comprise a first architected material 400 disposed between glass substrate 200 and frame 600, and a second architected material 400 attached to attachment 800.

In aspects, architected material 400 can be disposed under glass substrate 200. In such aspects, glass substrate 200 can be disposed over architected material 400. In aspects, architected material 400 can be attached to glass substrate 200. In aspects, architected material 400 can be attached to first surface 210 of glass substrate 200. In aspects, architected material 400 can be directly attached to first surface 210 of glass substrate 200. In aspects, architected material 400 can be attached to second surface 220 of glass substrate 200. In aspects, first surface 410 of architected material 400 can be attached to second surface 220 of glass substrate 200. In aspects, architected material 400 can be directly attached to second surface 220 of glass substrate 200.

In aspects, second surface 320 of adhesive layer 300 can be disposed on architected material 400. In such aspects, glass substrate 200 and architected material 400 can be directly attached via adhesive layer 300.

In aspects, second surface 320 of adhesive layer 300 can be disposed over electronic display 500. In aspects, electronic display 500 can be disposed over frame 600. In aspects, frame 600 can be disposed over back cover 700. In aspects, electronic display 500 can be attached to glass substrate 200. In aspects, electronic display 500 can be directly attached to first surface 210 of glass substrate 200. In aspects, electronic display 500 can be directly attached to second surface 220 of glass substrate 200. In aspects, frame 600 can be attached to glass substrate 200. In aspects, frame 600 can be directly attached to first surface 210 of glass substrate 200. In aspects, frame 600 can be directly attached to second surface 220 of glass substrate 200. In aspects, back cover 700 can be attached to glass substrate 200. In aspects, back cover 700 can be directly attached to first surface 210 of glass substrate 200. In aspects, back cover 700 can be directly attached to second surface 220 of glass substrate 200.

In aspects, electronic display 500 can be disposed over architected material 400. In aspects, architected material 400 can be attached to electronic display 500 (for example, via first surface 410 of architected material 400). In such aspects, architected material 400 can be disposed under second surface 220 of glass substrate 200. Accordingly, in aspects, architected material 400 can be disposed between glass substrate 200 and electronic display 500. In aspects, architected material 400 can be disposed under electronic display 500. In such aspects, architected material 400 can be disposed between glass substrate 200 and vehicle interior base 20. In such aspects, architected material 400 can be disposed between second surface 220 of glass substrate 200 and vehicle interior base 20.

Attachment 800 can comprise a first surface 810 and a second surface 820. Attachment 800 can attach display module 100 to vehicle interior 10. For example, in aspects, attachment 800 can attach display module 100 to vehicle base 20 disposed over a component of a vehicle dashboard 22. In aspects, attachment 800 can attach display module 100 to vehicle base 20 disposed over a component of a vehicle center console 24. In aspects, attachment 800 can attach display module 100 to vehicle base 20 disposed over a component of a vehicle instrument panel 26. In aspects, attachment 800 can attach display module 100 to vehicle base 20 disposed over a component of a vehicle steering wheel 28. In aspects, attachment 800 can attach display module 100 to vehicle base 20 disposed over a component of a vehicle seat back. In aspects, attachment 800 can attach display module 100 to vehicle base 20 disposed over a component of a vehicle seat front. In aspects, attachment 800 can attach display module 100 to vehicle base 20 disposed over a component of a vehicle door panel.

In aspects, back cover 700 can be disposed over attachment 800. In aspects, electronic display 500 can be disposed over back cover 700. In aspects, architected material 400 can be disposed over electronic display 500. In aspects, architected material 400 can be disposed between back cover 700 and electronic display 500.

In aspects, attachment 800 can be disposed over architected material 400. Accordingly, in aspects, architected material 400 can be disposed between attachment 800 and vehicle base 20.

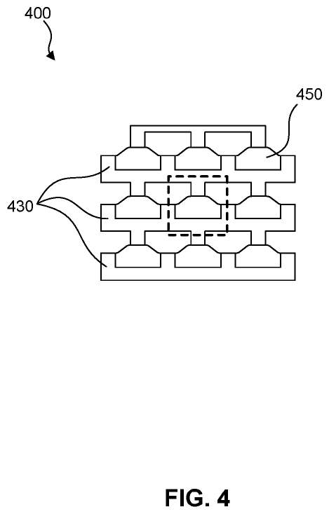

FIG. 4 shows a plurality of energy absorbing unit cells for an architected material 400 according to aspects. As shown in FIG. 4, architected material 400 can comprise one or more rows 430, each comprising a plurality of energy absorbing unit cells 450. For example, architected material 400 can comprise three rows 430, each row 430 having a plurality of energy absorbing unit cells 450. In other words, architected material 400 can comprise a plurality of energy absorbing unit cells 450 can be arranged in a plurality of rows 430. Architected material 400 can be a three-dimensional lattice structure comprising a plurality of energy absorbing unit cells 450. The geometry of architected material 400 can be designed for energy absorption to support display module 100 during impact. Accordingly, unit cells 450 can be referred to as energy absorbing unit cells.

In aspects, an architected material 400 disposed under glass substrate 200 can be disposed between glass substrate 200 and electronic display 500. With reference to FIG. 2, in aspects, architected material 400 can comprise a perimeter frame 401 and one or more openings 440 formed within the perimeter frame 401. In such aspects, electronic display 500 can be visible from a top surface of display module 100 through an opening 440 in architected material 400 disposed between glass substrate 200 and electronic display 500.

In aspects, architected material 400 can comprise a thickness 402 that is greater than a thickness 202 of glass substrate 200. Glass substrate 200 can have any suitable thickness 202. For example, glass substrate 200 can have a thickness 202 that is about 1.5 mm (millimeters) or less. For example, thickness 202 can be in a range from about 0.01 mm to about 1.5 mm, 0.02 mm to about 1.5 mm, 0.03 mm to about 1.5 mm, 0.04 mm to about 1.5 mm, 0.05 mm to about 1.5 mm, 0.06 mm to about 1.5 mm, 0.07 mm to about 1.5 mm, 0.08 mm to about 1.5 mm, 0.09 mm to about 1.5 mm, 0.1 mm to about 1.5 mm, from about 0.15 mm to about 1.5 mm, from about 0.2 mm to about 1.5 mm, from about 0.25 mm to about 1.5 mm, from about 0.3 mm to about 1.5 mm, from about 0.35 mm to about 1.5 mm, from about 0.4 mm to about 1.5 mm, from about 0.45 mm to about 1.5 mm, from about 0.5 mm to about 1.5 mm, from about 0.55 mm to about 1.5 mm, from about 0.6 mm to about 1.5 mm, from about 0.65 mm to about 1.5 mm, from about 0.7 mm to about 1.5 mm, from about 0.01 mm to about 1.4 mm, from about 0.01 mm to about 1.3 mm, from about 0.01 mm to about 1.2 mm, from about 0.01 mm to about 1.1 mm, from about 0.01 mm to about 1.05 mm, from about 0.01 mm to about 1 mm, from about 0.01 mm to about 0.95 mm, from about 0.01 mm to about 0.9 mm, from about 0.01 mm to about 0.85 mm, from about 0.01 mm to about 0.8 mm, from about 0.01 mm to about 0.75 mm, from about 0.01 mm to about 0.7 mm, from about 0.01 mm to about 0.65 mm, from about 0.01 mm to about 0.6 mm, from about 0.01 mm to about 0.55 mm, from about 0.01 mm to about 0.5 mm, from about 0.01 mm to about 0.4 mm, from about 0.01 mm to about 0.3 mm, from about 0.01 mm to about 0.2 mm, or from about 0.01 mm to about 0.1 mm.

Architected material 400 can have any suitable thickness 402. For example, architected material 400 can have a thickness 402 that can be in a range from about 0.5 mm to about 40 mm, about 0.5 mm to about 39.5 mm, about 0.5 mm to about 39 mm, about 0.5 mm to about 38.5 mm, about 0.5 mm to about 38 mm, about 0.5 mm to about 37.5 mm, about 0.5 mm to about 37 mm, about 0.5 mm to about 36.5 mm, about 0.5 mm to about 36 mm, about 0.5 mm to about 35.5 mm, about 0.5 mm to about 35 mm, about 0.5 mm to about 34.5 mm, about 0.5 mm to about 34 mm, about 0.5 mm to about 33.5 mm, about 0.5 mm to about 33 mm, about 0.5 mm to about 32.5 mm, about 0.5 mm to about 32 mm, about 0.5 mm to about 31.5 mm, about 0.5 mm to about 31 mm, about 0.5 mm to about 30.5 mm, about 0.5 mm to about 30 mm, about 0.5 mm to about 29.5 mm, about 0.5 mm to about 29 mm, about 0.5 mm to about 28.5 mm, about 0.5 mm to about 28 mm, about 0.5 mm to about 27.5 mm, about 0.5 mm to about 27 mm, about 0.5 mm to about 26.5 mm, about 0.5 mm to about 26 mm, about 0.5 mm to about 25.5 mm, about 0.5 mm to about 25 mm, about 0.5 mm to about 24.5 mm, about 0.5 mm to about 24 mm, about 0.5 mm to about 23.5 mm, about 0.5 mm to about 23 mm, about 0.5 mm to about 22.5 mm, about 0.5 mm to about 22 mm, about 0.5 mm to about 21.5 mm, about 0.5 mm to about 21 mm, about 0.5 mm to about 20.5 mm, about 0.5 mm to about 20 mm, about 0.5 mm to about 19.5 mm, about 0.5 mm to about 19 mm, about 0.5 mm to about 18.5 mm, about 0.5 mm to about 18 mm, about 0.5 mm to about 17.5 mm, about 0.5 mm to about 17 mm, about 0.5 mm to about 16.5 mm, about 0.5 mm to about 16 mm, about 0.5 mm to about 15.5 mm, about 0.5 mm to about 15 mm, about 0.5 mm to about 14.5 mm, about 0.5 mm to about 14 mm, about 0.5 mm to about 13.5 mm, about 0.5 mm to about 13 mm, about 0.5 mm to about 12.5 mm, about 0.5 mm to about 12 mm, about 0.5 mm to about 11.5 mm, about 0.5 mm to about 11 mm, about 0.5 mm to about 10.5 mm, about 0.5 mm to about 10 mm, about 0.5 mm to about 9.5 mm, about 0.5 mm to about 9 mm, about 0.5 mm to about 8.5 mm, about 0.5 mm to about 8 mm, about 0.5 mm to about 7.5 mm, about 0.5 mm to about 7 mm, about 0.5 mm to about 6.5 mm, about 0.5 mm to about 6 mm, about 0.5 mm to about 5.5 mm, about 0.5 mm to about 5 mm, about 0.5 mm to about 4.5 mm, about 0.5 mm to about 4 mm, about 0.5 mm to about 3.5 mm, about 0.5 mm to about 3 mm, about 0.5 mm to about 2.5 mm, or about 0.5 mm to about 2 mm.

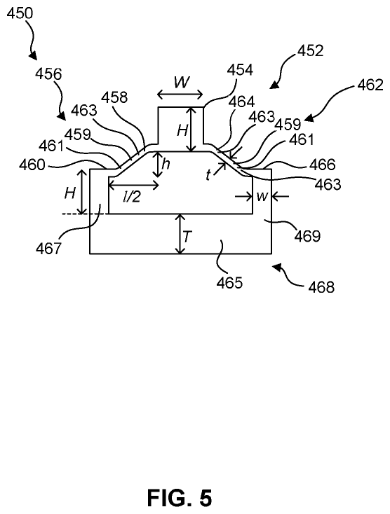

FIG. 5 shows an energy absorbing unit cell 450 of architected material 400 according to aspects. Energy absorbing unit cells 450 can comprise a top edge 452, a top wall 454, a first sidewall 456, a second sidewall 462, and a bottom wall 468. Top edge 452 can comprise top wall 454, first sidewall 456, and second sidewall 462. First sidewall 456 can comprise a first curved portion 458 and a first flat portion 460. Second sidewall 462 can comprise a second curved portion 464 and a second flat portion 466. Bottom wall 468 can comprise a first side 467, a second side 469, and a bottom side 465. Top wall 454 can extend from first curved portion 458 to second curved portion 464. Bottom wall 468 can extend from first flat portion 460 to second flat portion 466. In aspects, first curved portion 458 and second curved portion 464 can each comprise an S-shape defined by a first curved segment 461 and a second curved segment 463 connected at an inflection point 459.

In aspects, architected material 400 and components thereof can be made of PC ABS or a polymer foam. In aspects, architected material 400 and components thereof can include materials, designs, and properties described in Che, K., Yuan, C., Qi, H. J., & Meaud, J. (2018). Viscoelastic multistable architected materials with temperature-dependent snapping sequence. Soft Matter, 14 (13), 2492-2499.; Che, K., Yuan, C., Wu, J., Jerry Qi, H., & Meaud, J. (2016). Three-Dimensional-Printed Multistable Mechanical Metamaterials With a Deterministic Deformation Sequence. Journal of Applied Mechanics, 84 (1); Patel, P. S., Shepherd, D. E., & Hukins, D. W. (2008). Compressive properties of commercially available polyurethane foams as mechanical models for osteoporotic human cancellous bone. BMC Musculoskeletal Disorders, 9 (1); Restrepo, D., Mankame, N. D., & Zavattieri, P. D. (2015). Phase transforming cellular materials. Extreme Mechanics Letters, 4, 52-60; or Shan, S., Kang, S. H., Raney, J. R., Wang, P., Fang, L., Candido, F., Lewis, J. A., & Bertoldi, K. (2015). Multistable Architected Materials for Trapping Elastic Strain Energy. Advanced Materials, 27 (29), 4296-4301, which are incorporated herein in their entirety by reference thereto.

In aspects, a thickness of first curved portion 458 and second curved portion 464 is given by t. In aspects, t can range from about 0.5 mm to about 10 mm, including subranges. For example, in aspects, t can range from about 0.5 mm to about 9.5 mm, about 0.5 mm to about 9 mm, about 0.5 mm to about 8.5 mm, about 0.5 mm to about 8 mm, about 0.5 mm to about 7.5 mm, about 0.5 mm to about 7 mm, about 0.5 mm to about 6.5 mm, about 0.5 mm to about 6 mm, about 0.5 mm to about 5.5 mm, about 0.5 mm to about 5 mm, about 0.5 mm to about 4.5 mm, about 0.5 mm to about 4 mm, about 0.5 mm to about 3.5 mm, about 0.5 mm to about 3 mm, about 0.5 mm to about 2.5 mm, about 0.5 mm to about 2 mm, about 0.5 mm to about 1.5 mm, or about 0.5 mm to about 1 mm.

In aspects, a height of first curved portion 458 and second curved portion 464 is given by h. In aspects, h can range from about 0.5 mm to about 40 mm, including subranges. For example, in aspects, h can range from about 0.5 mm to about 39 mm, about 0.5 mm to about 38 mm, about 0.5 mm to about 37 mm, about 0.5 mm to about 36 mm, about 0.5 mm to about 35 mm, about 0.5 mm to about 34 mm, about 0.5 mm to about 33 mm, about 0.5 mm to about 32 mm, about 0.5 mm to about 31 mm, about 0.5 mm to about 30 mm, about 0.5 mm to about 29 mm, about 0.5 mm to about 28 mm, about 0.5 mm to about 27 mm, about 0.5 mm to about 26 mm, about 0.5 mm to about 25 mm, about 0.5 mm to about 24 mm, about 0.5 mm to about 23 mm, about 0.5 mm to about 22 mm, about 0.5 mm to about 21 mm, about 0.5 mm to about 20 mm, about 0.5 mm to about 19 mm, about 0.5 mm to about 18 mm, about 0.5 mm to about 17 mm, about 0.5 mm to about 16 mm, about 0.5 mm to about 15 mm, about 0.5 mm to about 14 mm, about 0.5 mm to about 13 mm, about 0.5 mm to about 12 mm, about 0.5 mm to about 11 mm, about 0.5 mm to about 10 mm, about 0.5 mm to about 9 mm, about 0.5 mm to about 8 mm, about 0.5 mm to about 7 mm, about 0.5 mm to about 6 mm, about 0.5 mm to about 5 mm, about 0.5 mm to about 4 mm, about 0.5 mm to about 3 mm, about 0.5 mm to about 2 mm, or about 0.5 mm to about 1 mm.

In aspects, a length of first curved portion 458 and second curved portion 464 is given by l/2. In aspects, l/2 can range from about 0.5 mm to about 40 mm, including subranges. For example, in aspects, l/2 can range from about 0.5 mm to about 39 mm, about 0.5 mm to about 38 mm, about 0.5 mm to about 37 mm, about 0.5 mm to about 36 mm, about 0.5 mm to about 35 mm, about 0.5 mm to about 34 mm, about 0.5 mm to about 33 mm, about 0.5 mm to about 32 mm, about 0.5 mm to about 31 mm, about 0.5 mm to about 30 mm, about 0.5 mm to about 29 mm, about 0.5 mm to about 28 mm, about 0.5 mm to about 27 mm, about 0.5 mm to about 26 mm, about 0.5 mm to about 25 mm, about 0.5 mm to about 24 mm, about 0.5 mm to about 23 mm, about 0.5 mm to about 22 mm, about 0.5 mm to about 21 mm, about 0.5 mm to about 20 mm, about 0.5 mm to about 19 mm, about 0.5 mm to about 18 mm, about 0.5 mm to about 17 mm, about 0.5 mm to about 16 mm, about 0.5 mm to about 15 mm, about 0.5 mm to about 14 mm, about 0.5 mm to about 13 mm, about 0.5 mm to about 12 mm, about 0.5 mm to about 11 mm, about 0.5 mm to about 10 mm, about 0.5 mm to about 9 mm, about 0.5 mm to about 8 mm, about 0.5 mm to about 7 mm, about 0.5 mm to about 6 mm, about 0.5 mm to about 5 mm, about 0.5 mm to about 4 mm, about 0.5 mm to about 3 mm, about 0.5 mm to about 2 mm, or about 0.5 mm to about 1 mm.

In aspects, a width of first side 467 and second side 469 of bottom wall 468 is given by w. In aspects, a width of top wall 454 is given by W. In aspects, W can equal 2w. In aspects, w can range from about 0.5 mm to about 40 mm, including subranges. For example, in aspects, w can range from about 0.5 mm to about 39 mm, about 0.5 mm to about 38 mm, about 0.5 mm to about 37 mm, about 0.5 mm to about 36 mm, about 0.5 mm to about 35 mm, about 0.5 mm to about 34 mm, about 0.5 mm to about 33 mm, about 0.5 mm to about 32 mm, about 0.5 mm to about 31 mm, about 0.5 mm to about 30 mm, about 0.5 mm to about 29 mm, about 0.5 mm to about 28 mm, about 0.5 mm to about 27 mm, about 0.5 mm to about 26 mm, about 0.5 mm to about 25 mm, about 0.5 mm to about 24 mm, about 0.5 mm to about 23 mm, about 0.5 mm to about 22 mm, about 0.5 mm to about 21 mm, about 0.5 mm to about 20 mm, about 0.5 mm to about 19 mm, about 0.5 mm to about 18 mm, about 0.5 mm to about 17 mm, about 0.5 mm to about 16 mm, about 0.5 mm to about 15 mm, about 0.5 mm to about 14 mm, about 0.5 mm to about 13 mm, about 0.5 mm to about 12 mm, about 0.5 mm to about 11 mm, about 0.5 mm to about 10 mm, about 0.5 mm to about 9 mm, about 0.5 mm to about 8 mm, about 0.5 mm to about 7 mm, about 0.5 mm to about 6 mm, about 0.5 mm to about 5 mm, about 0.5 mm to about 4 mm, about 0.5 mm to about 3 mm, about 0.5 mm to about 2 mm, or about 0.5 mm to about 1 mm.

In aspects, a height of bottom side 465 of bottom wall 468 is given by T. In aspects, T can range from about 0.5 mm to about 50 mm, including subranges. For example, in aspects, T can range from about 0.5 mm to about 45 mm, about 0.5 mm to about 40 mm, about 0.5 mm to about 35 mm, about 0.5 mm to about 30 mm, about 0.5 mm to about 25 mm, about 0.5 mm to about 20 mm, about 0.5 mm to about 15 mm, about 0.5 mm to about 10 mm, or about 0.5 mm to about 5 mm.

In aspects, a height of top wall 454, first side 467 of bottom wall 468, and second side 469 of bottom wall 468 is given by H. In aspects, H can range from about 0.5 mm to about 40 mm, including subranges. For example, in aspects, H can range from about 0.5 mm to about 39 mm, about 0.5 mm to about 38 mm, about 0.5 mm to about 37 mm, about 0.5 mm to about 36 mm, about 0.5 mm to about 35 mm, about 0.5 mm to about 34 mm, about 0.5 mm to about 33 mm, about 0.5 mm to about 32 mm, about 0.5 mm to about 31 mm, about 0.5 mm to about 30 mm, about 0.5 mm to about 29 mm, about 0.5 mm to about 28 mm, about 0.5 mm to about 27 mm, about 0.5 mm to about 26 mm, about 0.5 mm to about 25 mm, about 0.5 mm to about 24 mm, about 0.5 mm to about 23 mm, about 0.5 mm to about 22 mm, about 0.5 mm to about 21 mm, about 0.5 mm to about 20 mm, about 0.5 mm to about 19 mm, about 0.5 mm to about 18 mm, about 0.5 mm to about 17 mm, about 0.5 mm to about 16 mm, about 0.5 mm to about 15 mm, about 0.5 mm to about 14 mm, about 0.5 mm to about 13 mm, about 0.5 mm to about 12 mm, about 0.5 mm to about 11 mm, about 0.5 mm to about 10 mm, about 0.5 mm to about 9 mm, about 0.5 mm to about 8 mm, about 0.5 mm to about 7 mm, about 0.5 mm to about 6 mm, about 0.5 mm to about 5 mm, about 0.5 mm to about 4 mm, about 0.5 mm to about 3 mm, about 0.5 mm to about 2 mm, or about 0.5 mm to about 1 mm.

In aspects, the value of w can be greater than the value of t. In aspects, the value of w can be equal to the value of t. In aspects, the value of w can be less than the value of t. In aspects, the value of w can be greater than the value of T. In aspects, the value of w can be equal to the value of T. In aspects, the value of w can be less than the value of T.

In aspects, l/h can equal about 30. In aspects, h/t can equal about 10. In aspects, w can equal about 15t. In aspects, H can equal about 15t. In aspects, T can equal about 30t.

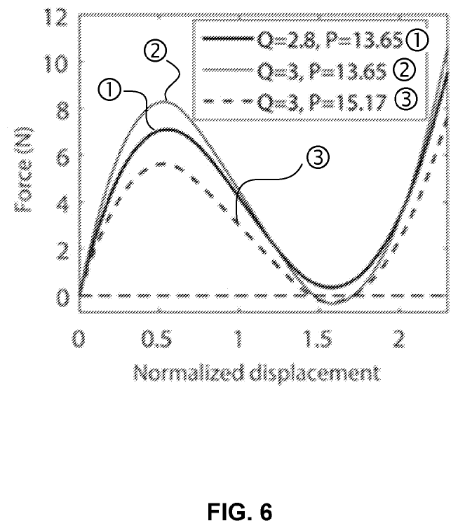

FIG. 6 shows a force versus normalized displacement curve for an energy absorbing unit cell 450 according to aspects. The force versus normalized displacement curve illustrates the mechanical behavior of the energy absorbing unit cell 450, and therefore an architected material 400 comprising energy absorbing unit cells 450, under a compressive load. The force versus displacement curve as shown in FIG. 6, shows the displacement of a top surface 451 of top edge 452 of an energy absorbing unit cell 450 according to aspects. As discussed herein, a force versus normalized displacement curve is a curved derived from a FEA (Finite Element Analysis) simulation applied to a modeled energy absorbing unit cell 450.

Energy absorbing unit cell 450 can comprise a variable compressive stiffness defined by a slope of a force versus normalized displacement curve for top surface 451 of top edge 452 of energy absorbing unit cells 450. The variable compressive stiffness of energy absorbing unit cell 450 can comprise a first positive slope region across of first range of normalized displacement, a negative slope region across a second range of normalized displacement, and a second positive slope region across a third range of normalized displacement. A force versus normalized displacement curve like the curve shown in FIG. 6 can illustrate the behavior of energy absorbing unit cell 450 under a compressive load. The negative slope region is a non-zero slope between the positive slope regions. The differences in stiffness can create a spring-like effect for energy absorbing unit cell 450, which can reduce headform deceleration and principal stress experienced by glass substrate 200 of a display module 100 during impact. In aspects, because the force value moves below zero, energy absorbing unit cells 450 can be bistable. In aspects, bistable energy absorbing unit cells 450 can then change configurations between deformed and initial states. In other aspects, the force can remain above zero such that energy absorbing unit cells 450 can be monostable.

In aspects, energy absorbing unit cells 450 that are bistable can absorb more energy than energy absorbing unit cells 450 that are monostable. In aspects, architected material 400 having a greater number of rows 430 can absorb more energy than architected material 400 having fewer rows 430.

In aspects, the variable compressive stiffness can transition from the first positive slope region to the negative slope region at a first critical force value. In aspects, the first critical force value can be between 4 Newtons and 10 Newtons. In aspects, the variable compressive stiffness can transition from the negative slope region to the second positive slope region at a second critical force value. In aspects, the first critical force value can be between-1 Newton and 4 Newtons. The critical force values can be functions of the size of architected material 400 (e.g., number of rows 430 and/or energy absorbing unit cells 450). For example, in aspects, the first critical force value can be equal to or greater than several hundred Newtons for example, greater than or equal to 100 Newtons, greater than or equal to 200 Newtons, greater than or equal to 300 Newtons, greater than or equal to 400 Newtons, or greater than or equal to 500 Newtons.

In aspects, a non-dimensional parameter P of energy absorbing unit cell 450 is given by l/t. In aspects, a non-dimensional parameter Q is given by h/t. The value of P can influence a peak force (e.g., a critical force) of the force versus normalized displacement curve and the stiffness of energy absorbing unit cells 450. The value of Q can be manipulated to achieve a negative slope region of the force versus displacement curve and can determine whether the energy absorbing unit cells 450 are monostable or bistable. In aspects, the value of Q can be greater than or equal to 2. In aspects, the value of Q can be greater than or equal to 2.5. In aspects, Q can be equal to or less than 15. In aspects, Q can be equal to or less than 10. In general, as the value of P is increased, the stiffness of energy absorbing unit cell 450 can be increased. In aspects, the value of P can be between about 13 and about 16.

In aspects, the force versus normalized displacement curve does not comprise a force value below zero. In such aspects, energy absorbing unit cell 450 can be considered a monostable unit cell. In aspects, the force versus normalized displacement curve comprises a force value below zero. In such aspects, energy absorbing unit cell 450 can be considered a bistable unit cell.

### EXAMPLES

Aspects will be further clarified by the following examples. It should be understood that these examples are not limiting to the aspects described above. To demonstrate the dynamic response of display modules comprising an architected material as described herein, the architected material was molded as being placed under a glass substrate or under an attachment of a modeled display module. FEA (finite element analysis) simulations were used to model HIT performance of the modeled display modules and compare the architected material to non-architected materials.

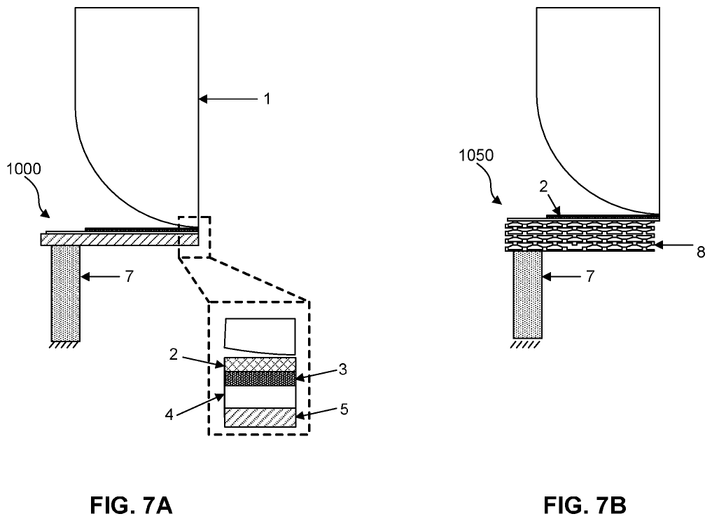

FIG. 7A shows a modeled display module 1000 for the FEA simulations with a glass substrate 2, an adhesive layer 3, a back cover 4, a frame 5, and an attachment 7. A modeled compressive force was applied to modeled display module 1000 with head form 1. Frame 5 was modeled as being made of solid PC ABS having the mechanical properties shown in Table 1 and as being made of a foam having the mechanical properties shown in Table 1.

FIG. 7B shows a modeled display module 1050 for the FEA simulations with a glass substrate 2, an adhesive layer 3, a back cover 4, an architected material 8, and an attachment 7. Modeled display module 1050 was the same as modeled display module 1000 with the exception that the frame 5 was replaced with architected material 8. The modeled architected material was modeled as a material comprising a plurality of rows of energy absorbing unit cells 450 composed of PC ABS having the mechanical properties shown in Table 1 and as a foam having the mechanical properties shown in Table 1. A modeled compressive force was applied to modeled display module 1050 with head form 1.

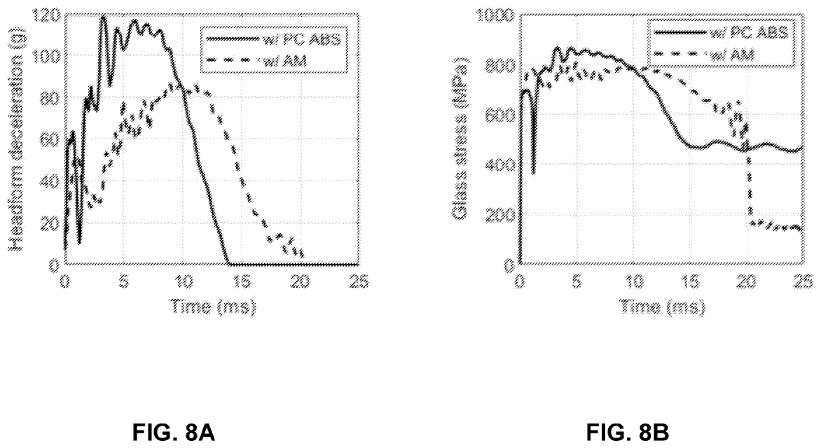

FIGS. 8A-B show the modeled HIT performance comparison between the modeled display module 1000 having a PC ABS frame 5 and the modeled display module 1050 having architected material 8 composed of PC ABS. FIG. 8A shows headform deceleration versus time. The results demonstrate that the maximum headform 3 ms (milliseconds) deceleration decreased 24.3% for the modeled display module 1050 compared to modeled display module 1000 having PC ABS. Additionally, the maximum headform deceleration decreased 27.7% for the modeled display module 1050 compared to modeled display module 1000 having PC ABS. FIG. 8B shows the maximum principal stress of glass substrate 2 versus time for modeled display module 1000 having a PC ABS frame 5 and the modeled display module 1050 having architected material 8 composed of PC ABS. The results demonstrate that the maximum principal stress decreased 7.1% for modeled display module 1050 compared to modeled display module 1000.

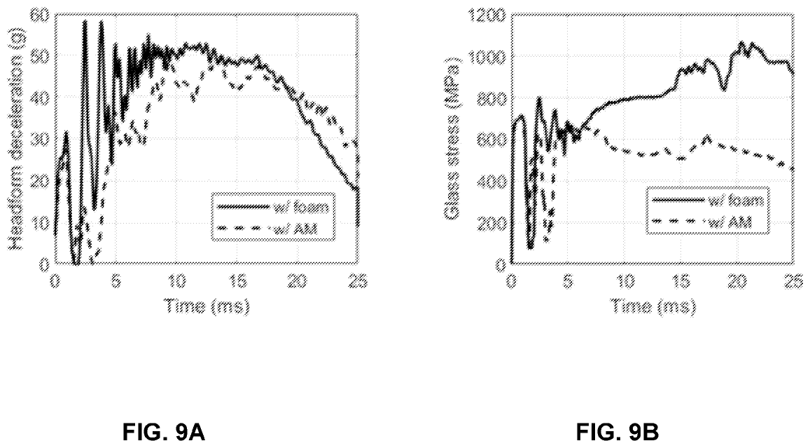

FIGS. 9A-B show the modeled HIT performance comparison between the modeled display module 1000 having a foam frame 5 and the modeled display module 1050 having architected material 8 composed of foam. FIG. 9A shows headform deceleration versus time. The results demonstrate that the maximum headform 3 ms deceleration decreased 14.3% for the modeled display module 1050 compared to modeled display module 1000 having foam. Additionally, the maximum headform deceleration decreased 15.5% for the modeled display module 1050 compared to modeled display module 1000 having foam. FIG. 9B shows the maximum principal stress of glass substrate 2 versus time for modeled display module 1000 having a foam frame 5 and the modeled display module 1050 having architected material 8 composed of foam. The results demonstrate that the maximum principal stress decreased 36.5% for modeled display module 1050 compared to modeled display module 1000.

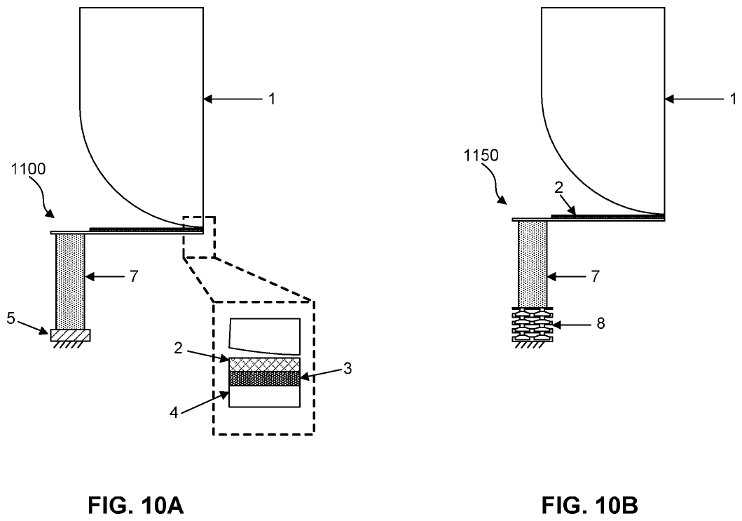

FIG. 10A shows a modeled display module 1100 for the FEA simulations with a glass substrate 2, an adhesive layer 3, a back cover 4, a frame 5, and an attachment 7. A modeled compressive force was applied to modeled display module 1100 with head form 1. Frame 5 was modeled as being made of solid PC ABS having the mechanical properties shown in Table 2 and as being made of a foam having the mechanical properties shown in Table 2.

FIG. 10B shows a modeled display module 1150 for the FEA simulations with a glass substrate 2, an adhesive layer 3, a back cover 4, an architected material 8, and an attachment 7. Modeled display module 1150 was the same as modeled display module 1100 with the exception that the frame 5 was replaced with architected material 8. The modeled architected material was modeled as a material comprising a plurality of rows of energy absorbing unit cells 450 composed of PC ABS having the mechanical properties shown in Table 2 and as a foam having the mechanical properties shown in Table 2. A modeled compressive force was applied to modeled display module 1150 with head form 2.

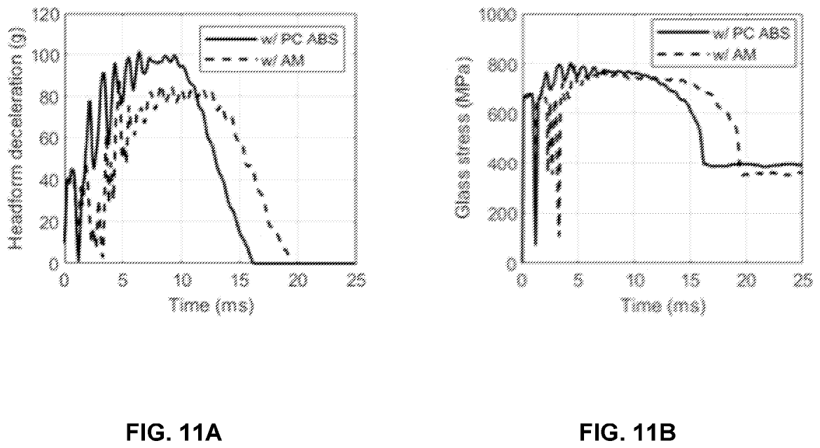

FIGS. 11A-B show the modeled HIT performance comparison between the modeled display module 1100 having a PC ABS frame 5 and the modeled display module 1150 having architected material 8 composed of PC ABS. FIG. 11A shows headform deceleration versus time. The results demonstrate that the maximum headform 3 ms deceleration decreased 18.1% for the modeled display module 1150 compared to modeled display module 1100 having PC ABS. Additionally, the maximum headform deceleration decreased 13.7% from modeled display module 1100 to modeled display module 1150 having PC ABS. FIG. 11B shows the maximum principal stress of glass substrate 2 versus time for modeled display module 1100 having a PC ABS frame 5 and the modeled display module 1150 having architected material 8 composed of PC ABS. The results demonstrate that the maximum principal stress decreased 1.4% for modeled display module 1150 compared to modeled display module 1100.

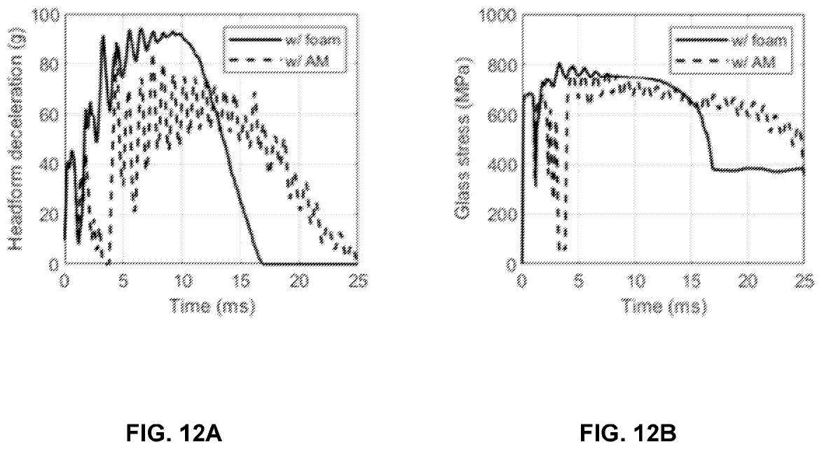

FIGS. 12A-B show the modeled HIT performance comparison between the modeled display module 1100 having a foam frame 5 and the modeled display module 1150 having architected material 8 composed of foam. FIG. 12A shows headform deceleration versus time. The results demonstrate that the maximum headform 3 ms deceleration decreased 39.8% for the modeled display module 1150 compared to modeled display module 1100 having foam. Additionally, the maximum headform deceleration decreased 6.4% from modeled display module 1100 to modeled display module 1150 having foam. FIG. 12B shows the maximum principal stress of glass substrate 2 versus time for modeled display module 1100 having a foam frame 5 and the modeled display module 1150 having architected material 8 composed of foam. The results demonstrate that the maximum principal stress decreased 1.5% for modeled display module 1150 compared to modeled display module 1100.

The dimensions and basic mechanical properties of each component of the modeled display modules in FIGS. 7A-B and FIGS. 10A-B are given in Table 1 and Table 2 below, respectively.

TABLE 1

| | | | | | | Architected | | | |
|---|---|---|---|---|---|---|---|---|---|
| | | | | Frame | | material | | | |
| | Glass | Adhesive | Back | PC | | PC | | | Head |
| | Substrate | layer | Cover | ABS | Foam | ABS | Foam | Attachment | form |
| Dimensions | 151 × | 151 × | 203 × | 210 × | 210 × | 210 × | 210 × | 3.05 (thick- | Ø165 |
| (mm) | 91 × 1.1 | 91 × 1.0 | 155 × 1.587 | 155 × 7.9 | 155 × 7.9 | 155 × 22.5 | 155 × 22.5 | ness) | |
| Young's | 69.3 | 4.5E−3 | 68.9 | 2.1 | 0.1514 | 2.1 | 0.1514 | 205 | 71 |
| modulus | | | | | | | | | |
| (GPa) | | | | | | | | | |
| Poisson's | 0.22 | 0.48 | 0.33 | 0.35 | 0.35 | 0.35 | 0.35 | 0.29 | 0.33 |
| ratio | | | | | | | | | |
| Density | 2400 | 800 | 2700 | 1100 | 320 | 1100 | 320 | 7850 | 2770 |
| (kg/m³) | | | | | | | | | |

TABLE 2

| | | | | | | Architected | | | |
|---|---|---|---|---|---|---|---|---|---|
| | | | | Frame | | material | | | |
| | Glass | Adhesive | Back | PC | | PC | | | Head |
| | Substrate | layer | Cover | ABS | Foam | ABS | Foam | Attachment | form |
| Dimensions | 151 × | 151 × | 203 × | 46.3 × | 46.3 × | 46.3 × | 210 × | 3.05 thick- | Ø165 |
| (mm) | 91 × 1.1 | 91 × 1.0 | 155 × 1.587 | 28 × 7.9 | 28 × 7.9 | 28 × 22.5 | 155 × 22.5 | ness | |
| Young's | 69.3 | 4.5E−3 | 68.9 | 2.1 | 0.1514 | 2.1 | 0.1514 | 205 | 71 |
| modulus | | | | | | | | | |
| (GPa) | | | | | | | | | |
| Poisson's | 0.22 | 0.48 | 0.33 | 0.35 | 0.35 | 0.35 | 0.35 | 0.29 | 0.33 |
| ratio | | | | | | | | | |
| Density | 2400 | 800 | 2700 | 1100 | 320 | 1100 | 320 | 7850 | 2770 |
| (kg/m³) | | | | | | | | | |

The modeled HIT performance comparisons between the modeled display modules 1000 and 1100 having a PC ABS frame 5 or a foam frame 5 and the modeled display modules 1050 and 1150 having architected material 8 show that an architected material as described herein effectively decreases headform deceleration compared to solid frames made of the same material. Accordingly, the results show that HIT performance can be improved and improved HIT regulation compliance can be achieved using architected materials as described herein. Additionally, the architected materials as described herein can effectively dissipate energy and decrease cover glass stress such that OEM glass substrate breakage can be reduced or prevented. The designed geometry of the architected materials described herein can achieve the improved HIT and breakage performance, and the performance is not dictated by only the material properties of the architected material.

While various aspects have been described herein, they have been presented by way of example, and not limitation. It should be apparent that adaptations and modifications are intended to be within the meaning and range of equivalents of the disclosed aspects, based on the teaching and guidance presented herein. It therefore will be apparent to one skilled in the art that various changes in form and detail can be made to the aspects disclosed herein without departing from the spirit and scope of the present disclosure. The elements of the aspects presented herein are not necessarily mutually exclusive, but may be interchanged to meet various situations as would be appreciated by one of skill in the art.

Aspects of the present disclosure are described in detail herein with reference to aspects thereof as illustrated in the accompanying drawings, in which like reference numerals are used to indicate identical or functionally similar elements. References to “aspects” or “an aspect” indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The indefinite articles “a” and “an” to describe an element or component means that one or more than one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

Directional terms as used herein—for example up, down, right, left, front, back, top, bottom, inward, outward—are made only with reference to the figures as drawn and are not intended to imply absolute orientation.

As used in the claims, “comprising” is an open-ended transitional phrase. A list of elements following the transitional phrase “comprising” is a non-exclusive list, such that elements in addition to those specifically recited in the list may also be present. As used in the claims, “consisting essentially of” or “composed essentially of” limits the composition of a material to the specified materials and those that do not materially affect the basic and novel characteristic(s) of the material. As used in the claims, “consisting of” or “composed entirely of” limits the composition of a material to the specified materials and excludes any material not specified.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two aspects: one modified by “about,” and one not modified by “about.”

As used herein, the term “about” refers to a value that is within ±5% of the value stated. For example, about 3 MPa can include any number between 2.85 MPa and 3.15 MPa.

It is to be understood that the phraseology or terminology used herein is for the purpose of description and not of limitation. The breadth and scope of the present disclosure should not be limited by any of the above-described exemplary aspects, but should be defined in accordance with the following claims and their equivalents.

1. A vehicle interior system, comprising:
a vehicle interior base; and
a display module disposed over the vehicle interior base, the display module comprising:
a glass substrate comprising a first surface and a second surface opposing the first surface,
an electronic display attached to the first surface of the glass substrate, and
an architected material comprising an energy absorbing unit cell,
wherein the energy absorbing unit cell comprises a variable compressive stiffness defined by a slope of a force versus normalized displacement curve for a top surface of a top edge of the energy absorbing unit cell, the variable compressive stiffness comprising: a first positive slope region across of first range of normalized displacement, a negative slope region across a second range of normalized displacement, and a second positive slope region across a third range of normalized displacement.

2. The vehicle interior system of claim 1, wherein the first surface of the glass substrate comprises a curved surface.

3. The vehicle interior system of claim 1, wherein the architected material is disposed between the first surface of the glass substrate and the vehicle interior base.

4. The vehicle interior system of claim 1, wherein the architected material is attached to the first surface of the glass substrate.

5. The vehicle interior system of claim 1, further comprising an attachment coupling the display module to the vehicle interior base, wherein the architected material is disposed between the attachment and the vehicle interior base.

6. The vehicle interior system of claim 1, wherein the architected material is attached to the vehicle interior base.

7. The vehicle interior system of claim 1, wherein the architected material comprises a plurality of the energy absorbing unit cells arranged in a plurality of rows.

8. The vehicle interior system of claim 1, wherein the display is visible through an opening formed in the architected material.

9. The vehicle interior system of claim 1, wherein the architected material comprises a thickness that is greater than a thickness of the glass substrate.

10. The vehicle interior system of claim 1, wherein the energy absorbing unit cell comprises:
a first sidewall comprising a first curved portion and a first flat portion; and
a second sidewall comprising a second curved portion and a second flat portion,
wherein a thickness of the first curved portion and a thickness of the second curved portion is given by t,
wherein a height of the first curved portion and a height of the second curved portion is given by t,
wherein a length of the first curved portion and a length of the second curved portion is given by l/2,
wherein a non-dimensional parameter P is given by l/t, and
wherein a non-dimensional parameter Q is given by h/t.

11. The vehicle interior system of claim 10, wherein the first curved portion and the second curved portion each comprise an S-shape defined by a first curved segment and a second curved segment connected at an inflection point.

12. The vehicle interior system of claim 10, wherein the value of Q is greater than or equal to 2.

13. The vehicle interior system of claim 10, wherein the value of P is between 13 and 16.

14. The vehicle interior system of claim 10, wherein the energy absorbing unit cell further comprises:
a top wall extending from the first curved portion to the second curved portion; and
a bottom wall extending from the first flat portion to the second flat portion.

15. The vehicle interior system of claim 14, wherein a width of the top wall is given by W,
wherein a width of a first side and a second side of the bottom wall is given by w,
wherein a height of a bottom side of the bottom wall is given by T,
wherein the value of w is greater than the value of t, and
wherein the value of w is less than the value of T.

16. The vehicle interior system of claim 1, wherein the force versus normalized displacement curve does not comprise a force value below zero.

17. The vehicle interior system of claim 1, wherein the force versus normalized displacement curve comprises a force value below zero.

18. The vehicle interior system of claim 1, wherein the variable compressive stiffness transitions from the first positive slope region to the negative slope region at a first critical force value.

19. The vehicle interior system of claim 1, wherein the variable compressive stiffness transitions from the negative slope region to the second positive slope region at a second critical force value.

20. The vehicle interior system of claim 1, wherein the vehicle interior base comprises at least one of: a component of a vehicle dashboard, a component of a vehicle center console, a component of a vehicle instrument panel, a component of a vehicle steering wheel, a component of a vehicle seat back, a component of a vehicle seat front, or a component of a vehicle door panel.

21. A vehicle interior system comprising:
a vehicle interior base;
a glass substrate comprising a first surface and a second surface opposing the first surface; and
an architected material disposed between the vehicle interior base and the glass substrate and comprising an energy absorbing unit cell,
wherein the energy absorbing unit cell comprises a variable compressive stiffness defined by a slope of a force versus normalized displacement curve for a top surface of a top edge of the energy absorbing unit cell, the variable compressive stiffness comprising: a first positive slope region across of first range of normalized displacement, a negative slope region across a second range of normalized displacement, and a second positive slope region across a third range of normalized displacement.
